(19) United States
(12) Patent Application Publication
(10) Pub. No.: US 2026/0106543 A1
(43) Pub. Date: Apr. 16, 2026

(54) POWER CONVERSION CIRCUIT AND CONTROL METHOD THEREOF FOR DETERMINING WHETHER TO DISCHARGE RESONANT CAPACITOR DURING STARTUP AND DISCHARGING THE RESONANT CAPACITOR WHEN NEEDED

(71) Applicant: Richtek Technology Corporation, Zhubei City (TW)

(72) Inventors: Ta-Yung YANG, Taoyuan City (TW); Kuo-Chi LIU, Hsinchu City (TW); Tzu-Chen LIN, Zhubei City (TW); Kun-Yu LIN, Zhubei City (TW)

(21) Appl. No.: 19/276,243

(22) Filed: Jul. 22, 2025

Related U.S. Application Data
(60) Provisional application No. 63/706,078, filed on Oct. 11, 2024.

(30) Foreign Application Priority Data
Jun. 16, 2025 (TW) 114122417

(51) Int. Cl. H02M 3/00; H02M 1/00; H02M 3/335

(52) U.S. Cl. CPC H02M 3/015; H02M 1/0009; H02M 1/0012; H02M 3/33523; H02M 3/33592

(57) ABSTRACT

A power conversion circuit includes a transformer, a resonant capacitor, a high-side transistor, a low-side transistor, and a control circuit. The transformer includes a primary coil, coupled between a switch node and a resonant node, and a secondary coil. The resonant capacitor is coupled between the resonant node and the ground. The resonant capacitor generates a resonant voltage. The high-side transistor provides an input voltage to the switch node based on a high-side driving signal. The low-side transistor couples the switch node to the ground based on the low-side driving signal. The control circuit generates the high-side driving signal and the low-side driving signal. When the control circuit executes a start-up process, the control circuit discharges the resonant capacitor based on the relationship between the resonant voltage and the output voltage.

### CROSS REFERENCE TO RELATED APPLICATIONS

This application claims the benefit of U.S. Provisional Application No. 63/706,078, filed on Oct. 11, 2024, the entirety of which is incorporated by reference herein.

This application claims priority of Taiwan Patent Application No. 114122417, filed on Jun. 16, 2025, the entirety of which is incorporated by reference herein.

### BACKGROUND OF THE INVENTION

### Field of the Invention

The disclosure is generally related to a power conversion circuit and a control method thereof, and more particularly it is related to a power conversion circuit and a control method thereof for determining whether a resonant capacitor needs to be discharged during startup, and for discharging the resonant capacitor when needed.

### Description of the Related Art

With the continuous advancements being made in portable electronic devices, the development of power conversion circuits, like most power products, has seen a trend toward higher efficiency, higher power density, better reliability, and lower costs. Since resonant power conversion circuits (which include LLC resonant power conversion circuits, flyback power conversion circuits, and others) are high-efficiency and high-power density power conversion circuits, the power conversion circuits used in portable electronic devices are gradually moving towards resonant power conversion circuits.

However, current resonant power conversion circuits still have many defects, so it is necessary to further optimize resonant power conversion circuits.

### BRIEF SUMMARY OF THE INVENTION

A power conversion circuit and a control method are provided herein. By determining whether the relationship between the resonant voltage and the output voltage is correct after receiving the input voltage and before starting to drive the high-side transistor and the low-side transistor, it determines whether to discharge the resonant capacitor to prevent bursting waves from occurring in the secondary coil of the transformer, which can reduce the lifespan of the components. In addition, the control circuit may detect the control voltage of the resonant voltage to connect an additional resonant capacitor to both terminals of the resonant capacitor in a light load state, thereby reducing the resonant frequency of the power conversion circuit, which improves the conversion efficiency of the light load state.

In an embodiment, a power conversion circuit for converting an input voltage to an output voltage is provided. The power conversion circuit comprises a transformer, a resonant capacitor, a high-side transistor, a low-side transistor, and a control circuit. The transformer comprises a primary coil and a secondary coil, wherein the primary coil is coupled between a switch node and a resonant node. The resonant capacitor is coupled between the resonant node and a ground and generating a resonant voltage. The high-side transistor provides the input voltage to the switch node based on a high-side driving signal. The low-side transistor couples the switch node to the ground based on a low-side driving signal. The control circuit generates the high-side driving signal and the low-side driving signal. When the control circuit executes a startup process, the control circuit discharges the resonant capacitor based on the resonant voltage and the output voltage.

According to an embodiment of the present invention, when the power conversion circuit receives the input voltage, the control circuit starts to execute the startup process. After the startup process, the power conversion circuit begins outputting an output voltage.

According to an embodiment of the present invention, when the power conversion circuit receives the input voltage, the control circuit starts to execute the startup process. When the startup process terminates, the control circuit starts generating the high-side driving signal and the low-side driving signal.

According to an embodiment of the present invention, the transformer further comprises an auxiliary coil for generating an auxiliary coil voltage. The power conversion circuit further comprises a first voltage-dividing circuit for multiplying the auxiliary coil voltage by a first voltage-dividing ratio to generate a demagnetization voltage. The secondary coil generates the output voltage.

According to an embodiment of the present invention, the power conversion circuit further comprises a detection resistor. The detection resistor is coupled between the resonant node and a control voltage. The control circuit determines a relationship between the demagnetization voltage and the control voltage in the startup process to determine whether to discharge the resonant capacitor.

According to an embodiment of the present invention, the control circuit further comprises a discharge resistor. The discharge resistor is coupled between the control voltage and the ground. The resonant voltage is multiplied by a second voltage-dividing ratio to generate the control voltage. The second voltage-dividing ratio is the resistance value of the discharge resistor divided by the sum of the resistance value of the discharge resistor and the resistance value of the detection resistor.

According to an embodiment of the present invention, the control circuit compares the demagnetization voltage and the control voltage in the startup process. When the control voltage exceeds the demagnetization voltage, the control circuit discharges the resonant capacitor. When the control voltage exceeds the demagnetization voltage, the control circuit adjusts the resistance value of the discharge resistor to adjust the discharge current for discharging the resonant capacitor. When the control voltage does not exceed the demagnetization voltage, the control voltage ends the startup process.

According to an embodiment of the present invention, the output voltage is the resonant voltage multiplied by the first ratio. The first ratio is the turn ratio of the number of turns in the secondary coil to the number of turns in the primary coil.

According to an embodiment of the present invention, the demagnetization voltage is the output voltage multiplied by a second ratio and also multiplied by a third ratio. The second ratio is a turn ratio of the number of turns in the auxiliary coil to the number of turns in the secondary coil. The third ratio is equal to the first voltage-dividing ratio. The product of the first ratio, the second ratio, the third ratio, and the reciprocal of the second voltage-dividing ratio is equal to 1.

According to an embodiment of the present invention, the power conversion circuit as claimed further comprises an additional resonant capacitor, a second voltage-dividing circuit, and a transistor. The additional resonant capacitor is coupled to the resonant node. The second voltage-dividing circuit divides the control voltage to generate a gate voltage. The transistor is coupled between the additional resonant capacitor and the ground.

According to an embodiment of the present invention, the control circuit further comprises a tri-state buffer and an analog-to-digital converter. The tri-state buffer controls the control voltage based on an enable signal and a load signal. The output terminal of the tri-state buffer is coupled to the control voltage. The analog-to-digital converter converts the control voltage to a digital code. The control circuit knows a voltage value of the control voltage based on the digital code.

According to an embodiment of the present invention, when the enable signal is enabled and the load signal is in a light load state, the tri-state buffer turns on the transistor such that the additional resonant capacitor is connected to the resonant capacitor in parallel to reduce a resonant frequency of the power conversion circuit, thereby reducing a switching frequency of the high-side driving signal and the low-side driving signal, which improves conversion efficiency.

According to an embodiment of the present invention, when the enable signal is disabled, the output terminal is in a high-impedance state such that the tri-state buffer is electrically isolated from the control voltage. When the enable signal is enabled and the load signal is in a heavy load state, the tri-state buffer turns off the transistor to maintain the resonant frequency of the power conversion circuit.

According to an embodiment of the present invention, the power conversion circuit is a resonant flyback power conversion circuit.

In another embodiment, a control method controlling a power conversion circuit for converting an input voltage to an output voltage is provided. The power conversion circuit comprises a resonant capacitor coupled between a resonant node and a ground, a transformer comprising a primary coil and a secondary coil, a high-side transistor providing the input voltage to a switch node, and a low-side transistor coupling the switch node to the ground. The primary coil is coupled between the switch node and the resonant node. The control method comprises the following steps. The input voltage is received. After the step of receiving the input voltage, it is determined whether to discharge the resonant capacitor based on the output voltage and a resonant voltage of the resonant node. When it is determined to discharge the resonant capacitor, the resonant capacitor is discharged. When it is determined not to discharge the resonant capacitor, driving the high-side transistor and the low-side transistor to generate the output voltage.

According to an embodiment of the present invention, the transformer further comprises an auxiliary coil generating an auxiliary coil voltage. The power conversion circuit further comprises a first voltage-dividing circuit multiplying the auxiliary coil voltage by a first voltage-dividing ratio to generate a demagnetization voltage. The secondary coil generates the output voltage.

According to an embodiment of the present invention, a detection resistor is coupled between the resonant node and a control voltage. The step of determining whether to discharge the resonant capacitor based on the output voltage and the resonant voltage of the resonant node further comprises the following steps. The demagnetization voltage and the control voltage are compared. When the control voltage exceeds the demagnetization voltage, it is determined to discharge the resonant capacitor. When the control voltage does not exceed the demagnetization voltage, it is determined not to discharge the resonant capacitor.

According to an embodiment of the present invention, a discharge resistor is coupled between the control voltage and the ground. The resonant voltage is multiplied by a second voltage-dividing ratio to generate the control voltage. The second voltage-dividing ratio is a resistance value of the discharge resistor divided by a sum of the resistance value of the discharge resistor and a resistance value of the detection resistor. The step of discharging the resonant capacitor when it is determined to discharge the resonant capacitor further comprises the following steps. The resistance value of the discharge resistor is adjusted to adjust a discharge current for discharging the resonant capacitor.

According to an embodiment of the present invention, the output voltage is the resonant voltage multiplied by a first ratio. The first ratio is a turn ratio of a number of turns in the secondary coil to a number of turns in the primary coil.

According to an embodiment of the present invention, the demagnetization voltage is the output voltage multiplied by a second ratio and also multiplied by a third ratio. The second ratio is a turn ratio of a number of turns in the auxiliary coil to a number of turns in the secondary coil. The third ratio is equal to the first voltage-dividing ratio. A product of the first ratio, the second ratio, the third ratio, and a reciprocal of the second voltage-dividing ratio is equal to 1.

According to an embodiment of the present invention, the control method further comprises the following steps. A load state of the output voltage is determined. When the load state is a light load state, an additional resonant capacitor is connected to the resonant capacitor in parallel to reduce a resonant frequency of the power conversion circuit, thereby reducing a switching frequency of the high-side transistor and the low-side transistor, which improves conversion efficiency. When the load signal is in a high-impedance state, the additional resonant capacitor is not connected to the resonant capacitor in parallel, which maintains the resonant frequency of the power conversion circuit.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of a power conversion circuit in accordance with an embodiment of the present invention;

FIG. 2 is a waveform diagram of a power conversion circuit in accordance with an embodiment of the present invention;

FIG. 3 is a block diagram of a power conversion circuit according to another embodiment of the present invention;

FIG. 4 is a block diagram of a power conversion circuit in accordance with yet another embodiment of the present invention;

FIG. 5 is a block diagram of a detection and adjustment circuit in accordance with an embodiment of the present invention; and

FIG. 6 is a flow chart of a control method of a power conversion circuit in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

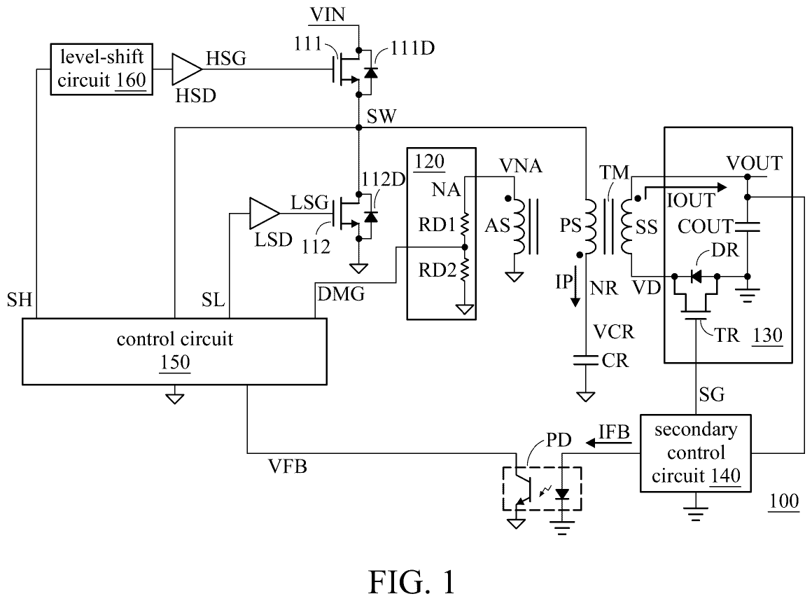

FIG. 1 is a block diagram of a power conversion circuit in accordance with an embodiment of the present invention. As shown in FIG. 1, the power conversion circuit 100 includes a high-side transistor 111, a low-side transistor 112, a resonant capacitor CR, a transformer TM, a first voltage-dividing circuit 120, a rectification circuit 130, a secondary control circuit 140, an opto-coupler PD, a control circuit 150, a level-shift circuit 160, a high-side driving circuit HSD, and a low-side driving circuit LSD.

The high-side transistor 111 provides an input voltage VIN to a switch node SW based on a high-side gate driving signal HSG. According to an embodiment of the present invention, the high-side transistor 111 includes a high-side parasitic diode 111D, where the high-side parasitic diode 111D is coupled between the switch node SW and the input voltage VIN. The low-side transistor 112 couples the switch node SW to the ground based on the low-side gate driving signal LSG. According to an embodiment of the present invention, the low-side transistor 112 includes a low-side parasitic diode 112D, where the low-side parasitic diode 112D is coupled between the switch node SW and the ground.

The resonant capacitor CR is coupled between the resonant node NR and the ground, and a resonant voltage VCR is generated across the resonant capacitor CR. The transformer TM includes a primary coil PS, a secondary coil SS, and an auxiliary coil AS. The primary coil PS is coupled between the switch node SW and the resonant node NR. The auxiliary coil AS is coupled between the auxiliary node NA and the ground, and an auxiliary coil voltage VNA is generated at the auxiliary node NA. The output current IOUT generated by the secondary coil SS generates an output voltage VOUT through the rectification circuit 130.

According to some embodiments of the present invention, the primary coil PS and the resonant capacitor CR are connected in series between the switch node SW and the ground. In other words, the resonant capacitor CR may be coupled between the switch node SW and the resonant node NR, and the primary coil PS may be coupled between the resonant node NR and the ground. The first voltage-dividing circuit 120 includes a first voltage-dividing resistor RD1 and a second voltage-dividing resistor RD2, which are configured to generate a demagnetization voltage DMG using the auxiliary coil voltage VNA.

The rectification circuit 130 is configured to convert the output current IOUT generated by the secondary coil SS into an output voltage VOUT, and includes a rectification transistor TR and an output capacitor COUT. According to some embodiments of the present invention, the rectification transistor TR further includes a rectification parasitic diode DR. The rectification transistor TR is turned on based on the gate signal SG, so that the output current IOUT output by the secondary coil SS charges the output capacitor COUT to generate the output voltage VOUT. When the rectification transistor TR is turned off, the voltage from the drain terminal to the source terminal of the rectification transistor TR is the drain voltage VD.

The secondary control circuit 140 generates a feedback current IFB based on the output voltage VOUT, where the feedback current IFB generates a feedback voltage VFB through the opto-coupler PD. The secondary control circuit 140 further generates the gate signal SG for converting the output current IOUT generated by the secondary coil SS into the output voltage VOUT.

The control circuit 150 generates a high-side driving signal SH and a low-side driving signal SL based on the feedback voltage VFB. The level-shift circuit 160 is configured to shift the voltage level of the high-side driving signal SH to the input voltage VIN, and the high-side drive circuit HSD generates the high-side gate driving signal HSG based on the shifted signal to drive the high-side transistor 111. The low-side driving circuit LSD generates a low-side gate driving signal LSG based on the low-side driving signal SL to drive the low-side transistor 112.

According to some embodiments of the present invention, the control circuit 150 further generates a high-side driving signal SH and a low-side driving signal SL according to the voltage of the switch node SW, so that both the high-side transistor 111 and the low-side transistor 112 achieve zero-voltage switching (ZVS), which improves the conversion efficiency of the power conversion circuit 100. According to some embodiments of the present invention, the power conversion circuit 100 may be a resonant power conversion circuit. According to some embodiments of the present invention, the power conversion circuit 100 may be a resonant flyback power conversion circuit. According to some embodiments of the present invention, the power conversion circuit 100 may be an asymmetrical half-bridge flyback power conversion circuit.

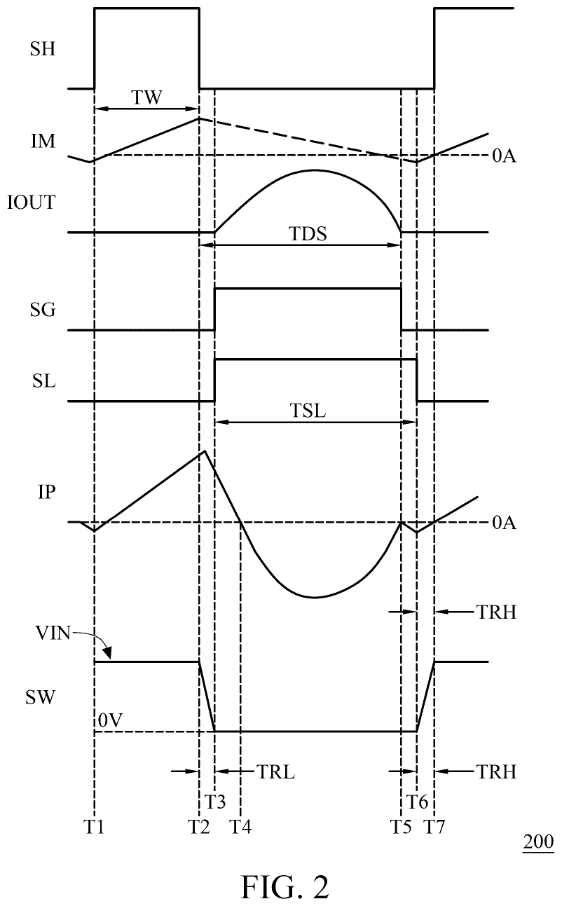

FIG. 2 is a waveform diagram of a power conversion circuit in accordance with an embodiment of the present invention. The following description of the waveform diagram 200 will be described in detail in conjunction with the power conversion circuit 100 of FIG. 1. From the first time point T1 to the second time point T2, the high-side transistor 111 is turned on based on the high-side driving signal SH (i.e., the high-side driving signal SH is at the high logic level). The high-side conduction time TW is the conduction time of the high-side transistor 111. During the high-side conduction time TW, the transformer TM is magnetized to generate a magnetizing current IM. As the conduction time TW increases, the magnetizing current IM of the transformer TM, the primary current IP flowing through the primary coil PS, and the resonant voltage VCR all increase accordingly. In other words, the high-side conduction time TW is the magnetizing time of the transformer TM.

When the high-side transistor 111 is turned off (i.e., the high-side driving signal SH is at the low logic level), the transformer 10 is demagnetizing. During the demagnetization period TDS, the transformer 10 generates an output current IOUT, and the conduction time of the low-side transistor 112 (i.e., the low-side driving signal SL is at the high logic level) corresponds to the demagnetization period TDS. According to some embodiments of the present invention, the low-side conduction time TSL of the low-side driving signal SL is equal to or greater than the demagnetization period TDS. During the demagnetization period TDS, the voltage across the primary coil PS is equal to the resonant voltage VCR, and the relationship between the resonant voltage VCR and the output voltage VOUT is as shown in Eq. 1.

$$\begin{matrix}V CR = n \times V OUT \\ n = \frac{NP}{NS}\end{matrix} \qquad ( Eq . 1 )$$

NP is the number of turns in the primary coil PS, NS is the number of turns in the secondary coil SS, and the turn ratio n is the number of turns in the primary coil PS divided by the number of turns in the secondary coil SS.

The demagnetization period TDS is shown in Eq. 2.

$$TDS = \frac{( V IN - V CR ) \times TW}{n \times V OUT} \qquad ( Eq . 2 )$$

When the high-side transistor 111 is turned on, (VIN-VCR) is the voltage configured to magnetize the transformer TM.

At the second time point T2, the high-side driving signal SH is converted to the low logic level to turn off the high-side transistor 111. At the third time point T3, the low-side driving signal SL is converted to the high logic level to turn on the low-side transistor 112. According to some embodiments of the present invention, the first dead time TRL from the second time point T2 to the third time point T3 is the dead time from the high-side transistor 111 being turned off to the low-side transistor 112 being turned on.

According to some embodiments of the present invention, during the first dead time TRL, the circulating current generated by the primary coil PS turns on the low-side parasitic diode 112D, and pulls down the voltage of the switch node SW, so that the low-side transistor 112 reaches zero-voltage switching. At the third time point T3, the voltage across the primary coil PS is the resonant voltage VCR of the resonant capacitor CR.

From the third time point T3 to the fourth time point T4, the high-side transistor 111 is turned off, and the low-side transistor 112 is turned on under zero-voltage switching. The rectification transistor TR is turned on, so that the output current IOUT flows through the rectification transistor TR to generate an output voltage VOUT, where the output voltage VOUT is equal to the resonant voltage VCR divided by the turn ratio n, as shown in Eq. 1. In addition, the primary current IP is still positive and flows into the resonant capacitor CR.

According to some embodiments of the present invention, the leakage inductance of the primary coil PS and the resonant capacitor CR form a resonant tank. The output current IOUT is in the form of a sine wave, and the frequency is determined by the resonant frequency of the resonant circuit. The primary current IP is the reflection of the magnetizing current IM plus the output current IOUT.

From the fourth time point T4 to the fifth time point T5, the high-side transistor 111 is continuously turned off and the low-side transistor 112 is continuously turned on. The energy of the transformer TM is continuously transferred to the secondary winding SS, and the energy at this time is provided by the resonant capacitor CR. In addition, since the low-side transistor 112 is continuously turned on, the energy of the resonant capacitor CR is configured to bring the magnetizing current IM to a negative value.

At the fifth time point T5, the rectification transistor TR is not turned on based on the gate signal SG, thereby ending the demagnetization period TDS. From the fifth time point T5 to the sixth time point T6, the resonant capacitor CR continues to reversely magnetize the primary winding PS, so that the primary current IP remains negative until the low-side transistor 112 is turned off.

From the sixth time point T6 to the seventh time point T7, the high-side transistor 111 and the low-side transistor 112 are both turned off, and the primary current IP induced as a negative current from the fifth time point T5 to the sixth time point T6 turns on the high-side parasitic diode 111D, so that the voltage of the switch node SW rises to the input voltage VIN. According to some embodiments of the present invention, the second dead time TRH from the sixth time point T6 to the seventh time point T7 is the dead time from the low-side transistor 112 being turned off to the high-side transistor 111 being turned on.

At the seventh time point T7, the high-side driving signal SH is at the high logic level. Since the voltage of the switch node SW rises to the input voltage VIN, the high-side transistor 111 is able to be turned under zero-voltage switching.

Since the resonant capacitor CR is connected in parallel with the primary coil PS when the transformer TM is demagnetized, the resonant voltage VCR is the output voltage VOUT multiplied by the turn ratio of the transformer TM. When the voltage difference between the resonant voltage VCR and the output voltage VOUT multiplied by the turn ratio is too large, the drain voltage VD would generate a very high voltage spike, reducing the reliability of the rectification transistor TR and even damaging the rectification transistor TR.

Under normal operation, the resonant voltage VCR would be very close to the voltage value of the output voltage VOUT multiplied by the turn ratio of the transformer TM, thereby avoiding the generation of voltage spike at the drain voltage VD. However, when the power conversion circuit 100 is turned on and off quickly and frequently, the output voltage VOUT would be discharged through the load, making the difference between the resonant voltage VCR and the output voltage VOUT multiplied by the turn ratio of the transformer TM significant, thereby causing a voltage spike at the drain voltage VD. In order to protect the rectification transistor TR from being damaged by voltage spike, it is necessary to optimize the power conversion circuit 100.

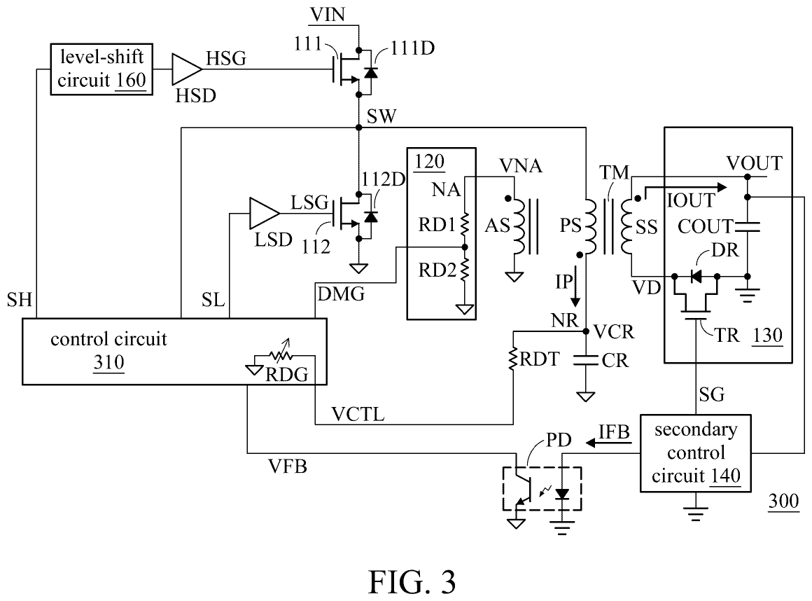

FIG. 3 is a block diagram of a power conversion circuit according to another embodiment of the present invention. Comparing the power conversion circuit 300 of FIG. 3 with the power conversion circuit 100 of FIG. 1, the power conversion circuit 300 further includes a detection resistor RDT, and the control circuit 150 of the power conversion circuit 100 is replaced by a control circuit 310.

The detection resistor RDT is coupled between the resonant node NR and the control voltage VCTL. According to an embodiment of the present invention, when the power conversion circuit 300 receives the input voltage VIN, the control circuit 310 executes the startup process and starts driving the high-side transistor 111 and the low-side transistor 112 after the startup process is completed, thereby generating the output voltage VOUT. When the control circuit 310 executes the startup process, the control circuit 310 determines whether the resonant capacitor CR needs to be discharged based on the relationship between the control voltage VCTL and the demagnetization voltage DMG.

According to some embodiments of the present invention, when the current does not flow through the detection resistor RDT, the resonant voltage VCR is equal to the control voltage VCTL. In other words, the control circuit 310 determines whether the resonant capacitor CR needs to be discharged based on the relationship between the resonant voltage VCR and the demagnetization voltage DMG. In general, the control circuit 310 may determine whether the resonant capacitor CR needs to be discharged based on the relationship between the resonant voltage VCR and the demagnetization voltage DMG, or based on the relationship between the control voltage VCTL and the demagnetization voltage DMG. That is, the control voltage VCTL is configured to represent the resonant voltage VCR.

According to an embodiment of the present invention, when the resonant voltage VCR exceeds the demagnetization voltage DMG, the control circuit 310 determines that the resonant capacitor CR needs to be discharged. According to another embodiment of the present invention, when the resonant voltage VCR does not exceed the demagnetization voltage DMG, the control circuit 310 determines that there is no need to discharge the resonant capacitor CR.

As shown in FIG. 3, the control circuit 310 further includes a discharge resistor RDG, where the discharge resistor RDG is coupled between the control voltage VCTL and the ground. According to some embodiments of the present invention, when it is determined that discharge of the resonant capacitor CR is required, the control circuit 310 may adjust the resistance value of the discharge resistance RDG, so as to adjust the magnitude of the discharge current for discharging the resonant capacitor CR.

For simplifying the description, FIG. 3 shows that the discharge resistor RDG is coupled to the control voltage VCTL. According to other embodiments of the present invention, when the control circuit 310 determines that it is necessary to discharge the resonant capacitor CR, the control circuit 310 may couple the discharge resistor RDG to the control voltage VCTL after the resistance value of the discharge resistor RDG has been adjusted.

According to some embodiments of the present invention, when the resonant voltage VCR of the resonant capacitor CR is discharged until the control voltage VCTL does not exceed the demagnetization voltage DMG, the control circuit 310 ends the startup process and starts to generate the high-side driving signal HS and the low-side driving signal LS to drive the high-side transistor 111 and the low-side transistor 112.

The relationship between the resonant voltage VCR and the output voltage VOUT shown in Eq. 1 that may be rewritten to Eq. 3.

$$\begin{matrix}V OUT = \frac{1}{n} \times V CR \\ n = \frac{NP}{NS}\end{matrix} \qquad ( Eq . 3 )$$

The relationship between the auxiliary coil voltage VNA and the output voltage VOUT is shown in Eq. 4.

$$\begin{matrix}V NA = m \times V OUT \\ m = \frac{NAS}{NS}\end{matrix} \qquad ( Eq . 4 )$$

NAS is the number of turns in the auxiliary coil AS, NS is the number of turns in the secondary coil SS, and the turns ratio m is the number of turns in the auxiliary coil AS divided by the number of turns in the secondary coil SS.

The relationship between the demagnetization voltage DMG and the auxiliary coil voltage VNA is as shown in Eq. 5, where d1 is the voltage-dividing ratio of the first voltage-dividing circuit 120. In other words, d1 is equal to the resistance value of the second voltage-dividing resistor RD2 divided by the sum of the resistance value of the first voltage-dividing resistor RD1 and the resistance value of the second voltage-dividing resistor RD2.

$$\begin{matrix}DMG = d 1 \times V NA \\ d 1 = \frac{RD 2}{RD 1 + RD 2}\end{matrix} \qquad ( Eq . 5 )$$

The relationship between the control voltage VCTL and the resonant voltage VCR is as shown in Eq. 6, where d2 is the resistance value of the discharge resistor RDG divided by the sum of the resistance value of the discharge resistor RDG and the resistance value of the detection resistor RDT.

$$\begin{matrix}V CTL = d 2 \times V CR \\ d 2 = \frac{RDG}{RDG + RDT}\end{matrix} \qquad ( Eq . 6 )$$

Combining Eq. 3, Eq. 4, Eq. 5 and Eq. 6, the relationship between the demagnetization voltage DMG and the control voltage VCTL is shown in Eq. 7.

$$DMG = d 1 \times m \times \frac{1}{4} \times \frac{1}{d 2} \times V CTL \qquad ( Eq . 7 )$$

According to some embodiments of the present invention, for the sake of evaluating, the product of d1, m,

$$\frac{1}{n} and \frac{1}{d 2}$$

may be adjusted to be equal to 1, so that when the output voltage VOUT is stably output, the demagnetization voltage DMG is equal to the control voltage VCTL. In other words, when the product of d1, m,

$$\frac{1}{n} and \frac{1}{d 2}$$

is equal to 1 and the control voltage VCTL exceeds the demagnetization voltage DMG, it means that the resonant voltage VCR is too high. The control circuit 310 determines that it is necessary to discharge the resonant capacitor CR, and adjusts the discharge current to discharge the resonant capacitor CR by adjusting the resistance value of the discharge resistance RDG.

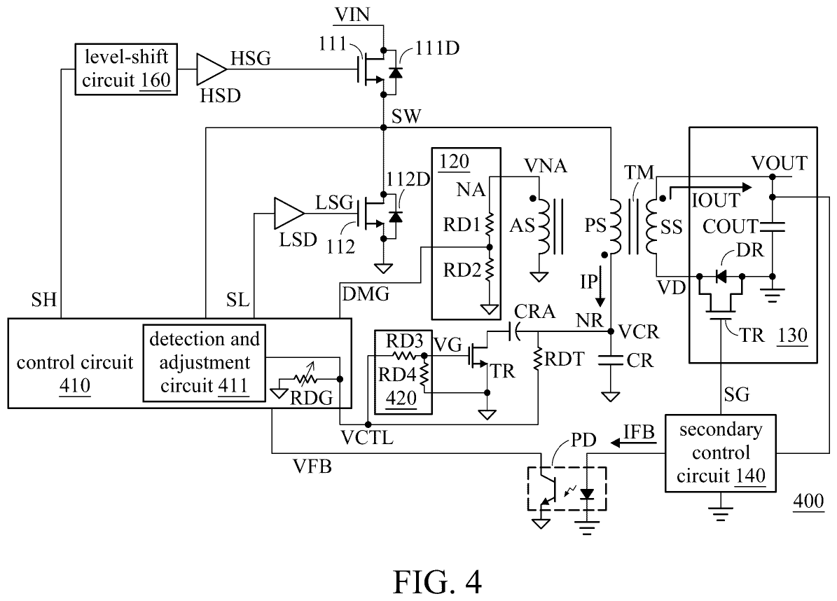

FIG. 4 is a block diagram of a power conversion circuit in accordance with yet another embodiment of the present invention. Compared the power conversion circuit 400 in FIG. 4 to the power conversion circuit in FIG. 3, the power conversion circuit 400 further includes an additional resonant capacitor CRA, a second voltage-dividing circuit 420, and a transistor TR, and the control circuit 410 of the power conversion circuit 400 further includes a detection and adjustment circuit 411.

The additional resonant capacitor CRA is coupled to the resonant node NR, and the second voltage-dividing circuit 420 includes a third voltage-dividing resistor RD3 and a fourth voltage-dividing resistor RD4 to divide the control voltage VCTL to generate a gate voltage VG. The transistor TR is coupled between the additional resonant capacitor CRA and the ground and is controlled by the gate voltage VG. The detection and adjustment circuit 411 is configured to detect the control voltage VCTL, and turns on the transistor TR through the control voltage VCTL based on the load state of the output voltage VOUT, thereby connecting the additional resonant capacitor CRA to the resonant capacitor CR in parallel.

According to an embodiment of the present invention, when the load state of the output voltage VOUT is a light load state (that is, the power of the output voltage VOUT is low), the detection and adjustment circuit 411 turns on the transistor TR through the control voltage VCTL, thereby connecting the additional resonant capacitor CRA to the resonant capacitor CR in parallel. According to another embodiment of the present invention, when the load state of the output voltage VOUT is a heavy load state (i.e., the power of the output voltage VOUT is relatively high), the detection and adjustment circuit 411 turns off the transistor TR.

According to some embodiments of the present invention, when the additional resonant capacitor CRA is connected in parallel to the resonant capacitor CR, the resonant frequency of the power conversion circuit 400 is thus reduced, so that the operating frequency of the driving high-side transistor 111 and the low-side transistor 112 is reduced, thereby increasing the conversion efficiency of the output voltage VOUT in a low load state. According to other embodiments of the present invention, when the additional resonant capacitor CRA is not connected in parallel to the resonant capacitor CR, the power conversion circuit 400 maintains the same resonant frequency.

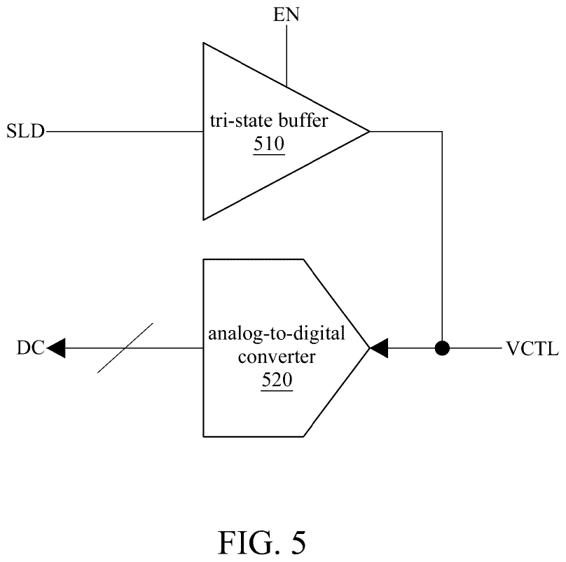

FIG. 5 is a block diagram of a detection and adjustment circuit in accordance with an embodiment of the present invention. As shown in FIG. 5, the detection and adjustment circuit 500 includes a tri-state buffer 510 and an analog-to-digital converter 520. The output end of the tri-state buffer 510 is coupled to the control voltage VCTL, and controls the control voltage VCTL based on the enable signal EN and the load signal SLD.

According to an embodiment of the present invention, when the enable signal EN is disabled, the output terminal of the tri-state buffer 510 is in a high-impedance state. That is, when the enable signal EN is disabled, it is equivalent to the tri-state buffer 510 electrically separated from the control voltage VCTL.

According to another embodiment of the present invention, when the enable signal EN is enabled, the tri-state buffer 510 supplies the load signal SLD to the control voltage VCTL. The analog-to-digital converter 520 is configured to convert the control voltage VCTL into a digital code DC, where the control circuit 410 knows the magnitude of the control voltage VCTL based on the digital code DC.

According to an embodiment of the present invention, when the load state of the output voltage VOUT is in a light load state, the tri-state buffer 510 enables the control voltage VCTL based on the enable signal EN and the load signal SLD of the light load state, thereby turning on the transistor TR in FIG. 4 to connect the additional resonant capacitor CRA to the resonant capacitor CR in parallel. According to another embodiment of the present invention, when the load state of the output voltage VOUT is in a heavy load state, the tri-state buffer 510 disables the control voltage VCTL based on the enable signal EN and the load signal SLD of the heavy load state, thereby turning off the transistor TR.

According to some embodiments of the present invention, the control circuit 410 sets the load signal SLD to a light load state or a heavy load state based on the feedback voltage VFB. According to an embodiment of the present invention, when the power of the output voltage VOUT increases so that the feedback voltage VFB exceeds a threshold, the control circuit 410 sets the load signal SLD to the heavy load state. According to another embodiment of the present invention, when the power of the output voltage VOUT is reduced such that the feedback voltage VFB does not exceed the threshold, the control circuit 410 sets the load signal SLD to a light load state.

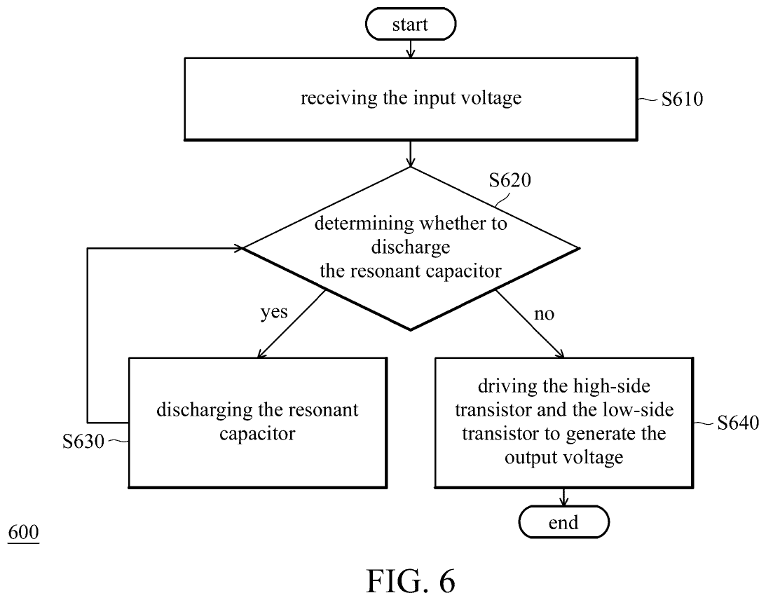

FIG. 6 is a flow chart of a control method of a power conversion circuit in accordance with an embodiment of the present invention. As shown in the control method 600 of FIG. 6, first, the input voltage VIN is received (Step S610). After receiving the input voltage VIN, it is determined whether to discharge the resonant capacitor CR (Step S620). According to some embodiments of the present invention, the control circuit 310 decides whether to discharge the resonant capacitor CR based on the relationship between the output voltage VOUT and the resonant voltage VCR. According to some embodiments of the present invention, the control circuit 310 determines whether the relationship between the resonant voltage VCR and the output voltage VOUT is as shown in Eq. 1 to decide whether to discharge the resonant capacitor CR.

According to another embodiment of the present invention, the control circuit 310 decides whether to discharge the resonant capacitor CR based on the relationship between the demagnetization voltage DMG and the resonant voltage VCR. According to another embodiment of the present invention, the control circuit 310 compares the demagnetization voltage DMG and the control voltage VCTL to determine whether the relationship between the demagnetization voltage DMG and the control voltage VCTL is as shown in Eq. 7, thereby determining whether to discharge the resonant capacitor CR. According to other embodiments of the present invention, the control circuit 310 may compares the demagnetization voltage DMG and the control voltage VCTL to determine whether the relationship between the demagnetization voltage DMG and the control voltage VCTL is as shown in the combination of Eq. 3, Eq. 4, and Eq. 5, thereby determining whether to discharge the resonant capacitor CR.

When it is determined in Step S620 that the resonant capacitor CR needs to be discharged, the resonant capacitor CR is discharged (Step S630). According to an embodiment of the present invention, the control circuit 310 discharges the resonant capacitor CR through the detection resistor RDT, and adjusts the magnitude of the discharge current by adjusting the resistance value of the discharge resistor RDG.

When it is determined in Step S620 that the resonant capacitor CR is not required to be discharged, the high-side transistor 111 and the low-side transistor 112 are started being driven (Step S640). According to some embodiments of the present invention, Step S610 to Step S630 are the startup process. According to an embodiment of the present invention, when performing Step S630 to discharge the resonant capacitor CR, Step S620 is simultaneously executed to determine whether it is necessary to continue discharging the resonant capacitor CR. Once Step S620 determines that the resonant capacitor CR is not required to continue discharging, Step S640 is performed.

According to another embodiment of the present invention, after executing Step S630 for a period of time, return to Step S620 to determine again whether it is necessary to continue discharging the resonant capacitor CR. In other words, when the resonant capacitor CR has been discharged by performing Step S630, the relationship between the resonant capacitor CR and the output voltage VOUT is continuously monitored to facilitate the timely entry of Step S640 to end the startup process.

A power conversion circuit and a control method are provided herein. By determining whether the relationship between the resonant voltage and the output voltage is correct after receiving the input voltage and before starting to drive the high-side transistor and the low-side transistor, it determines whether to discharge the resonant capacitor to prevent bursting waves from occurring in the secondary coil of the transformer, which can reduce the lifespan of the components. In addition, the control circuit may detect the control voltage of the resonant voltage to connect an additional resonant capacitor to both terminals of the resonant capacitor in a light load state, thereby reducing the resonant frequency of the power conversion circuit, which improves the conversion efficiency of the light load state.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit for converting an input voltage to an output voltage, comprising:
a transformer, comprising a primary coil and a secondary coil, wherein the primary coil is coupled between a switch node and a resonant node;
a resonant capacitor, coupled between the resonant node and a ground and generating a resonant voltage;
a high-side transistor, providing the input voltage to the switch node based on a high-side driving signal;
a low-side transistor, coupling the switch node to the ground based on a low-side driving signal; and
a control circuit, generating the high-side driving signal and the low-side driving signal;
wherein when the control circuit executes a startup process, the control circuit discharges the resonant capacitor based on the resonant voltage and the output voltage.

2. The power conversion circuit as claimed in claim 1, wherein when the power conversion circuit receives the input voltage, the control circuit starts to execute the startup process;
wherein after the startup process, the power conversion circuit begins outputting an output voltage.

3. The power conversion circuit as claimed in claim 1, wherein when the power conversion circuit receives the input voltage, the control circuit starts to execute the startup process;
wherein when the startup process terminates, the control circuit starts generating the high-side driving signal and the low-side driving signal.

4. The power conversion circuit as claimed in claim 1, wherein the transformer further comprises an auxiliary coil for generating an auxiliary coil voltage;
wherein the power conversion circuit further comprises a first voltage-dividing circuit for multiplying the auxiliary coil voltage by a first voltage-dividing ratio to generate a demagnetization voltage;
wherein the secondary coil generates the output voltage.

5. The power conversion circuit as claimed in claim 4, further comprising:
a detection resistor, coupled between the resonant node and a control voltage;
wherein the control circuit determines a relationship between the demagnetization voltage and the control voltage in the startup process to determine whether to discharge the resonant capacitor.

6. The power conversion circuit as claimed in claim 5, wherein the control circuit further comprises:
a discharge resistor, coupled between the control voltage and the ground;
wherein the resonant voltage is multiplied by a second voltage-dividing ratio to generate the control voltage;
wherein the second voltage-dividing ratio is a resistance value of the discharge resistor divided by a sum of the resistance value of the discharge resistor and a resistance value of the detection resistor.

7. The power conversion circuit as claimed in claim 6, wherein the control circuit compares the demagnetization voltage and the control voltage in the startup process;
wherein when the control voltage exceeds the demagnetization voltage, the control circuit discharges the resonant capacitor;
wherein when the control voltage exceeds the demagnetization voltage, the control circuit adjusts the resistance value of the discharge resistor to adjust a discharge current for discharging the resonant capacitor;
wherein when the control voltage does not exceed the demagnetization voltage, the control voltage ends the startup process.

8. The power conversion circuit as claimed in claim 6, wherein the output voltage is resonant voltage multiplied by a first ratio;
wherein the first ratio is a turn ratio of number of turns in the secondary coil to number of turns in the primary coil.

9. The power conversion circuit as claimed in claim 8, wherein the demagnetization voltage is the output voltage multiplied by a second ratio and also multiplied by a third ratio;
wherein the second ratio is a turn ratio of number of turns in the auxiliary coil to number of turns in the secondary coil;
wherein the third ratio is equal to the first voltage-dividing ratio;
wherein a product of the first ratio, the second ratio, the third ratio, and a reciprocal of the second voltage-dividing ratio is equal to 1.

10. The power conversion circuit as claimed in claim 6, further comprising:
an additional resonant capacitor, coupled to the resonant node;
a second voltage-dividing circuit, dividing the control voltage to generate a gate voltage; and
a transistor, coupled between the additional resonant capacitor and the ground.

11. The power conversion circuit as claimed in claim 10, wherein the control circuit further comprises:
a tri-state buffer, controlling the control voltage based on an enable signal and a load signal, wherein an output terminal of the tri-state buffer is coupled to the control voltage; and
an analog-to-digital converter, converting the control voltage to a digital code;
wherein the control circuit knows a voltage value of the control voltage based on the digital code.

12. The power conversion circuit as claimed in claim 11, wherein when the enable signal is enabled and the load signal is in a light load state, the tri-state buffer turns on the transistor such that the additional resonant capacitor is connected to the resonant capacitor in parallel to reduce a resonant frequency of the power conversion circuit, thereby reducing a switching frequency of the high-side driving signal and the low-side driving signal to improve conversion efficiency.

13. The power conversion circuit as claimed in claim 12, wherein when the enable signal is disabled, the output terminal is in a high-impedance state such that the tri-state buffer is electrically isolated from the control voltage;
wherein when the enable signal is enabled and the load signal is in a heavy load state, the tri-state buffer turns off the transistor to maintain the resonant frequency of the power conversion circuit.

14. The power conversion circuit as claimed in claim 1, wherein the power conversion circuit is a resonant flyback power conversion circuit.

15. A control method controlling a power conversion circuit for converting an input voltage to an output voltage, wherein the power conversion circuit comprises a resonant capacitor coupled between a resonant node and a ground, a transformer comprising a primary coil and a secondary coil, a high-side transistor providing the input voltage to a switch node, and a low-side transistor coupling the switch node to the ground, wherein the primary coil is coupled between the switch node and the resonant node, wherein the control method comprises:
receiving the input voltage;
after the step of receiving the input voltage, determining whether to discharge the resonant capacitor based on the output voltage and a resonant voltage of the resonant node;
when it is determined to discharge the resonant capacitor, discharging the resonant capacitor; and
when it is determined not to discharge the resonant capacitor, driving the high-side transistor and the low-side transistor to generate the output voltage.

16. The control method as claimed in claim 15, wherein the transformer further comprises an auxiliary coil generating an auxiliary coil voltage;
wherein the power conversion circuit further comprises a first voltage-dividing circuit multiplying the auxiliary coil voltage by a first voltage-dividing ratio to generate a demagnetization voltage;
wherein the secondary coil generates the output voltage.

17. The control method as claimed in claim 16, wherein a detection resistor is coupled between the resonant node and a control voltage;
wherein the step of determining whether to discharge the resonant capacitor based on the output voltage and the resonant voltage of the resonant node further comprises:
comparing the demagnetization voltage and the control voltage;
when the control voltage exceeds the demagnetization voltage, determining to discharge the resonant capacitor; and
when the control voltage does not exceed the demagnetization voltage, determining not to discharge the resonant capacitor.

18. The control method as claimed in claim 17, wherein a discharge resistor is coupled between the control voltage and the ground;
wherein the resonant voltage is multiplied by a second voltage-dividing ratio to generate the control voltage;
wherein the second voltage-dividing ratio is a resistance value of the discharge resistor divided by a sum of the resistance value of the discharge resistor and a resistance value of the detection resistor;
wherein the step of discharging the resonant capacitor when it is determined to discharge the resonant capacitor further comprises:
adjusting the resistance value of the discharge resistor to adjust a discharge current for discharging the resonant capacitor.

19. The control method as claimed in claim 18, wherein the output voltage is the resonant voltage multiplied by a first ratio;
wherein the first ratio is a turn ratio of number of turns in the secondary coil to number of turns in the primary coil.

20. The control method as claimed in claim 19, wherein the demagnetization voltage is the output voltage multiplied by a second ratio and also multiplied by a third ratio;
wherein the second ratio is a turn ratio of number of turns in the auxiliary coil to number of turns in the secondary coil;
wherein the third ratio is equal to the first voltage-dividing ratio;
wherein a product of the first ratio, the second ratio, the third ratio, and a reciprocal of the second voltage-dividing ratio is equal to 1.

21. The control method as claimed in claim 15, further comprising:
determining a load state of the output voltage;
when the load state is a light load state, connecting an additional resonant capacitor to the resonant capacitor in parallel to reduce a resonant frequency of the power conversion circuit, thereby reducing a switching frequency of the high-side transistor and the low-side transistor to improve conversion efficiency; and
when the load signal is in a high-impedance state, not connecting the additional resonant capacitor to the resonant capacitor in parallel to maintain the resonant frequency of the power conversion circuit.
